(19) United States
(12) Patent Application Publication
(10) Pub. No.: US 2022/0284487 A1
(43) Pub. Date: Sep. 8, 2022

(54) Real-Time Revenue Assurance System For Operational Toll Management And A Method Thereof

(71) Applicant: KPMG Assurance and Consulting Services LLP, 400011 (IN)

(72) Inventors: Vaibhav LANKE, Maharashtra (IN); Arjun MALHOTRA, Haryana (IN)

(21) Appl. No.: 17/192,229

(22) Filed: Mar. 4, 2021

(51) Int. Cl. G06Q 30/04; G06F 16/25; G06F 16/26

(52) U.S. Cl. CPC G06Q 30/04; G06F 16/258; G06F 16/26; G06Q 2240/00

(57) ABSTRACT

The present disclosure is utilised to identify exceptions pertaining to revenue leakages, operational inefficiencies from the data obtained by a toll management system and method for reporting trends, key insights to management. The system and method identifies revenue leakage in the toll operations based on a plurality of data obtained by the toll management system and is capable of providing real time monitoring of toll operations. The revenue leakage and reporting of trends is done on the basis of analysis of different predefined parameters to identify various trends and insights.

### TECHNICAL FIELD OF THE DISCLOSURE

The present disclosure generally relates to toll management and more particularly to a system and method to identify exceptions pertaining to revenue leakages, operational inefficiencies from the data obtained by toll management systems.

### BACKGROUND

The current toll industry is subjected to large quantum of transactions carried out on a day to day basis. The toll industry is certainly not immune to revenue disruption due to various factors such as irregular classification of vehicles, incorrect toll collections due to human error in entering the toll amount by toll collectors, exemptions offered by toll plazas may vary, change of toll rates by regulatory authority prior to approval dates etc. Such situations lead to revenue leakages leading to loss in toll operation. Moreover, accurate reconciliation process becomes difficult to achieve as collection of inaccurate tolls may go unnoticed due to such unidentified revenue leakages. Therefore, there is a need for an improved operating efficiency of tolls wherein identification of the revenue leakages is required. However, reviewing and validating the voluminous transactional data to identify such revenue leakages is a complex activity since it is influenced by various external and internal factors as different tolls may have varied data classification methods.

US20130006725A1 discloses a tolling system to perform various operations, which include identifying tolling data sources in a network; constructing a toll pricing model based on the identified tolling data sources; integrating tolling data from two or more of the identified tolling data sources, the tolling data including data describing characteristics of road usage by an entity; and determining a tolling charge incurred by the entity in accordance with the toll pricing model based on the integrated tolling data. In some example implementations, the integrated tolling data may be collected by at least two different tolling data sources that collect different types of tolling data.

Further, Indian patent application 4213/CHE/2015 discloses a Toll Management System with integration of pre-classification and post-classification facilitated by a digital audit mechanism. The present invention is related to a Toll Management System that comprises a first auditing processor which receives and processes a AVC classification data related to a vehicle and a transactional classification data related to the vehicle, it identifies a mismatch in the AVC classification data and the transactional classification data, and then to fetches it to a media content correlated to the vehicle with mismatch of AVC classification data and transactional classification data. An AVC database is made to store AVC classification data of vehicles entering a lane of a Toll and it provides AVC classification data to the auditing computing device, and the AVC classification data is generated from AVC sensing data collected by an AVC sensor when a vehicle is entering a lane for toll collection. A transactional database stores transactional classification data of vehicle, and the transactional classification data is provided by a transaction computing device when the toll is collected, wherein transactional classification data and the AVC classification of vehicle is related to a category of the vehicle based on weight and size of the vehicle, the AVC sensing data relates to weight and/or size of the vehicle, the media content is either a video and/or an image indexed to the vehicle.

However, all the above-mentioned algorithms fail to provide an efficient method for revenue management on operating tolls, which determines deviation from operations and identifies revenue leakage based on wide range of key performance indicators, wherein the key performance indicators are developed based on proprietary audit knowledge and identification of exceptional situations pertaining to the revenue leakage. Therefore, there exists a need for an efficient method for managing and analysing revenue data of operating tolls.

### SUMMARY

One or more shortcomings of prior art are overcome, and additional advantages are provided through the present disclosure. Additional features are realized through techniques of the present disclosure. Other embodiments and aspects of the disclosure are described in detail herein and are considered a part of the present disclosure.

The present disclosure describes a real-time revenue assurance system for detecting one or more revenue leakages in a plurality of operational tolls wherein the system comprises a data input module for aggregating a plurality of data associated with at least one toll by a user through a communication interface; a first data repository for storing the aggregated data obtained from the data input module; a second data repository for storing a set of predefined parameters selected by the user; and a data processing module to perform an assessment of the aggregated data associated with the at least one toll against the set of predefined parameters stored in the second repository selected by the user to detect one or more revenue leakages to generate a plurality of revenue leakage trend reports.

The present disclosure further provides a method for detecting real-time one or more revenue leakages in a plurality of operational tolls wherein the method comprises firstly aggregating a plurality of data associated with at least one toll by a user through a communication interface in a data input module; secondly storing the aggregated data obtained from the data input module into a first data repository; and thirdly detecting one or more revenue leakages based on an assessment of the aggregated data associated with at least one toll against a set of predefined parameters stored in a second repository selected by the user.

Foregoing summary is illustrative only and is not intended to be in any way limiting. In addition to illustrative aspects, embodiments, and features described above, further aspects, embodiments, and features will become apparent by reference to drawings and following detailed description.

### BRIEF DESCRIPTION OF DRAWINGS

FIG. 1 shows different components of the system for revenue assurance for operation toll roads

FIG. 2 is flowchart diagram which shows the different stages of the process carried out for detecting revenue leakage in a plurality of operation tolls

### DETAILED DESCRIPTION

In following detailed description of embodiments of present disclosure, numerous specific details are set forth in order to provide a thorough understanding of the embodiments of the disclosure. However, it will be obvious to one skilled in art that the embodiments of the disclosure may be practiced without these specific details. In other instances, well known methods, procedures, components, and circuits have not been described in detail so as not to unnecessarily obscure aspects of the embodiments of the disclosure.

References in the present disclosure to “one embodiment” or “an embodiment” mean that a feature, structure, characteristic, or function described in connection with the embodiment is included in at least one embodiment of the disclosure. Appearances of phrase “in one embodiment” in various places in the present disclosure are not necessarily all referring to same embodiment.

In the present disclosure, word “exemplary” is used herein to mean “serving as an example, instance, or illustration.” Any embodiment or implementation of present subject matter described herein as “exemplary” is not necessarily to be construed as preferred or advantageous over other embodiments.

The present disclosure may take form of a hardware embodiment, a software embodiment, or an embodiment combining software and hardware aspects that may all generally be referred to herein as a ‘system’ or a ‘module’. Further, the present disclosure may take form of a computer program product embodied in a storage device having computer readable program code embodied in a medium.

While the disclosure is susceptible to various modifications and alternative forms, specific embodiment thereof has been shown by way of example in drawings and will be described in detail below. It should be understood, however that it is not intended to limit the disclosure to the forms disclosed, but on contrary, the disclosure is to cover all modifications, equivalents, and alternative falling within scope of the disclosure.

Terms such as “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude existence of other elements or additional elements in the system or apparatus.

In following detailed description of the embodiments of the disclosure, reference is made to drawings that form a part hereof, and in which are shown by way of illustration specific embodiments in which the disclosure may be practiced. These embodiments are described in enough detail to enable those skilled in the art to practice the disclosure, and it is to be understood that other embodiments may be utilized and that changes may be made without departing from the scope of the present disclosure. The following description is, therefore, not to be taken in a limiting sense.

In the view of making toll operations more efficient various toll operations use diverse ways to collect the charges levied namely. Cash, POS and ETC for vehicles passing through the designated tollways. These charges are in accordance with the charges mentioned in the Concession Agreements that toll operators have entered with the authorities. There are various penalties which also can be levied in accordance with the concession agreements. All the tolls have different charges and a different concession agreement.

Conventionally, the toll operator at the toll plaza has a Toll Management Software (TMS) containing pre-defined master, which have the charges to be collected from various vehicles based on their classifications of such vehicles. The toll operators need to classify the vehicle and accordingly collect the charges at the toll plaza. The same is captured in the TMS and a ticket is generated. Various other interments such as AVCC which classifies the vehicle independently. This classification is also captured in TMS. In case there are differences between the classification as per the toll operator and AVCC, such exceptions need to be resolved by the auditors.

There are various ways in which there may be possibilities of revenue leakages, classification of vehicle improper, same vehicle classified differently in two different journeys etc. All such types of exceptions are picked up by out tool through data analytics. Approximately 40 parameters have been defined, such as incorrect exemptions, partial exemptions, exemptions issues between multiple toll plazas, rates revised prior to approved date, toll penalties not charged for overweight vehicles, incorrect weight captured for some vehicles, duplicate records in data etc.

The present disclosure relates in general to a system and method of revenue assurance for operation toll roads which analyses transactions and evaluates them on the basis of certain predefined parameters stored in the system repository. It offers a unique solution to analyze tolling data. The data collected by different tolling systems and/or platforms are standardized and fed to the tool. The tool uses numerous predefined parameters to analyze the tolling data. The said predefined parameters are defined based on proprietary audit knowledge obtained by previous audits conducted on various toll operations, some examples of predefined parameters are incorrect classifications, inconsistencies in classification between multiple toll plazas, issues around blacklisting and declined transaction etc. which in turn helps to identify exceptional situations that leads to such revenue leakages and reports it to the management which could further take decisions regarding rectifying such situations.

Further the invention also provide the trends of revenue such as plaza wise revenue, vehicle class wise trend, trend of authorized exemptions etc. and identify exceptional situations of revenue leakage. So that management could gain key insights needed for making better decisions.

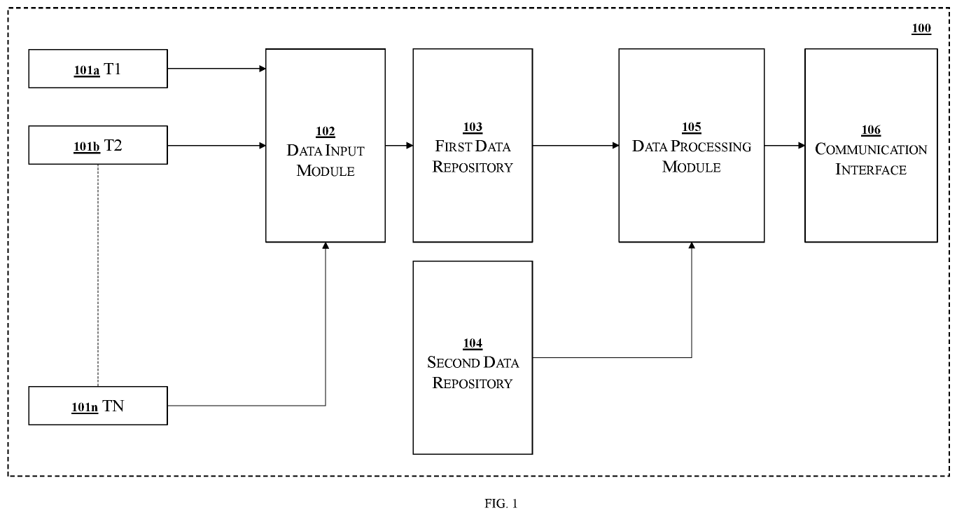

FIG. 1 explains different components of the system for revenue assurance for operation toll roads 100. The system comprises a plurality of tolls T1 (101a), T2 (101b) . . . TN (101n) corresponding to different toll booths. The system collects the transaction data and other data parameters from the plurality of tolls T1 (101a), T2 (101b) . . . TN (101n) and forwards the data to a data input module (102). The data input module (102) collects data from multiple TMS, and aggregates the data. The data aggregated by the data input module is then stored in a first repository (103). The system also contains a second repository (104), which stores various predefined parameters selected by a user of the system. The predefined parameters can be related to vehicle classification, toll exemption, toll collection issues, incorrect exemptions, partial exemptions, exemptions issues between multiple toll plazas, rates revised prior to approved date, toll penalties not charged for overweight vehicles, incorrect weight captured for some vehicles, duplicate records in data etc. Further, a data processing module (105) performs an assessment of the aggregated data stored in the first repository (103) in accordance with predefined parameters stored in the second repository (104). Based on the assessment, the data processing module (105) detects revenue leakages and generates trend reports. The revenue leakage and trend reports are presented to the user through a communication interface (106), wherein the communication interface (106) contains multiple dashboards which enable real-time monitoring of revenue flow with dynamic reporting by applying time slicers without any undue delay. Herein the system (100) enables real-time monitoring of revenue flow by continuously refreshing the transaction data and other data parameters obtained from the plurality of tolls T1 (101a), T2 (101b) . . . TN (101n).

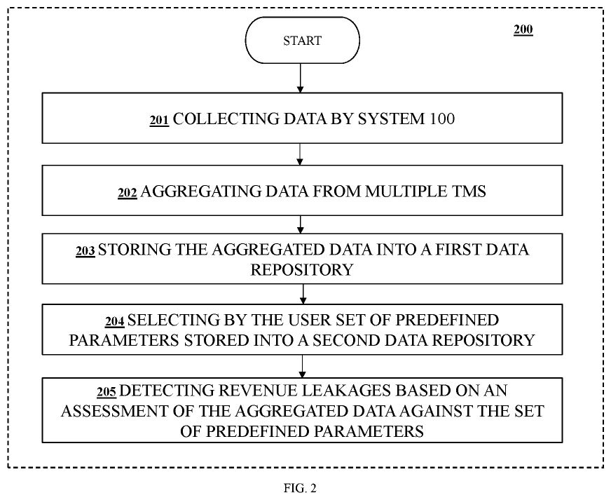

FIG. 2 is a flowchart diagram which shows the different stages of the process carried out for detecting revenue leakage in a plurality of operation tolls. At step 201, the system (100) collects data corresponding to various transactions at a specific toll. At 202, the data collected by the system (100) is aggregated by the data input module (102). The data aggregated is stored in a first repository (103) at step 203. At step 204, the user selects a set of predefined parameters wherein the predefined parameters are stored in the second repository (104). At step 205, the aggregated data is analysed on the basis of the user selected parameters to detect possible revenue leakage and generate trends.

In the present implementation, the system (100) includes one or more processors. The processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory. The system further includes I/O interfaces, memory and modules.

The I/O interfaces may include a variety of software and hardware interfaces, for example, a web interface, a graphical user interface, and the like. The I/O interface may allow the system to interact with a user directly or through user devices. Further, the I/O interface may enable the system (100) to communicate with other user devices or computing devices, such as web servers. The I/O interface can facilitate multiple communications within a wide variety of networks and protocol types, including wired networks, for example, LAN, cable, etc., and wireless networks, such as WLAN, cellular, or satellite. The I/O interface may include one or more ports for connecting number of devices to one another or to another server.

The memory may be coupled to the processor. The memory can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the system (100) includes modules. The modules include routines, programs, objects, components, data structures, etc., which perform tasks or implement particular abstract data types. In one implementation, module includes a display module and other modules. The other modules may include programs or coded instructions that supplement applications and functions of the system (100).

As described above, the modules, amongst other things, include routines, programs, objects, components, and data structures, which perform particular tasks or implement particular abstract data types. The modules may also be implemented as, signal processor(s), state machine(s), logic circuitries, and/or any other device or component that manipulate signals based on operational instructions. Further, the modules can be implemented by one or more hardware components, by computer-readable instructions executed by a processing unit, or by a combination thereof.

Furthermore, one or more computer-readable storage media may be utilized in implementing some of the embodiments consistent with the present disclosure. A computer-readable storage medium refers to any type of physical memory on which information or data readable by a processor may be stored. Thus, the computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

We claim:

1. A real-time revenue assurance system for detecting one or more revenue leakages in a plurality of operational tolls, the system comprising:
a data input module for aggregating a plurality of data associated with at least one toll by a user through a communication interface;
a first data repository for storing the aggregated data obtained from the data input module;
a second data repository for storing a set of predefined parameters selected by the user;
a data processing module to perform an assessment of the aggregated data associated with the at least one toll against the set of predefined parameters stored in the second repository selected by the user to detect one or more revenue leakages to generate a plurality of revenue leakage trend reports.

2. The real-time system as claimed in claim 1, wherein the real-time system further comprises a data reporting module to render the plurality of revenue leakage trend reports through the communication interface by means of a plurality of dashboards including but not limited to an overall trend of revenue including plaza-wise revenue, vehicle-class wise trend, trend of authorized exemptions to detect exceptional situations of revenue leakage.

3. The real-time system as claimed in claim 1, wherein the predefined parameters include but not limited to vehicle classification, toll exemption, toll collection issues, incorrect exemptions, partial exemptions, exemptions issues between multiple toll plazas, rates revised prior to approved date, toll penalties not charged for overweight vehicles, incorrect weight captured for some vehicles, duplicate records in data.

4. The real-time system as claimed in claim 1, wherein the plurality of dashboards enables real-time monitoring of revenue flow with dynamic reporting by applying time slicers without any undue delay.

5. The real-time system as claimed in claim 1, wherein the data includes but not limited to structured and unstructured data wherein the unstructured data is converted to structured data by the data processing module.

6. The real-time system as claimed in claim 1, wherein the aggregated data is fetched from multiple operational tolls.

7. A method for detecting real-time one or more revenue leakages in a plurality of operational tolls, the method comprising:
aggregating a plurality of data associated with at least one toll by a user through a communication interface in a data input module;
storing the aggregated data obtained from the data input module into a first data repository;
detecting one or more revenue leakages based on an assessment of the aggregated data associated with at least one toll against a set of predefined parameters stored in a second repository selected by the user.

8. The method as claimed in claim 7, wherein the method further comprises rendering the plurality of revenue leakage trend reports through the communication interface by means of a plurality of dashboards including but not limited to an overall trend of revenue including plaza-wise revenue, vehicle-class wise trend, trend of authorized exemptions to detect exceptional situations of revenue leakage through a data reporting module.

9. The method as claimed in claim 7, wherein the predefined parameters include but not limited to vehicle classification, toll exemption, toll collection issues, incorrect exemptions, partial exemptions, exemptions issues between multiple toll plazas, rates revised prior to approved date, toll penalties not charged for overweight vehicles, incorrect weight captured for some vehicles, duplicate records in data.

10. The method as claimed in claim 7, wherein the plurality of dashboards enables real-time monitoring of revenue flow with dynamic reporting by applying time slicers without any undue delay.

11. The method as claimed in claim 7, wherein the data includes but not limited to structured and unstructured data wherein the unstructured data is converted to structured data by the data processing module.

12. The method as claimed in claim 7, wherein the aggregated data is fetched from multiple operational tolls.
